(19) United States
(12) Patent Application Publication
(10) Pub. No.: US 2003/0123917 A1
(43) Pub. Date: Jul. 3, 2003

(54) Tubular deformable sleeve and related apparatus

(76) Inventors: Boyd Willat, Los Angeles, CA (US); Ted Caligiuri, Encinitas, CA (US); Dan Kostrikin, Los Angeles, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/278,654

(22) Filed: Oct. 23, 2002

Related U.S. Application Data
(63) Continuation of application No. 09/483,807, filed on Jan. 15, 2000, now abandoned.

(51) Int. Cl. A46B 5/02; E05B 1/00

(52) U.S. Cl. 401/6; 16/435

(57) ABSTRACT

A deformable sleeve for attachment to various products for use as a grip and/or to provide a stylish appearance. The deformable sleeve features two membranes that define a cavity filled with a formable material. The deformation of the sleeve results in greater comfort for the user where the sleeve is mounted on products that are manually manipulated or are otherwise contacted by the user. In one preferred embodiment, the sleeve can be mounted on a writing instrument for use as a grip. Alternatively, the sleeve can be filled with a formable material that will resume its original shape after being deformed.

### BACKGROUND OF THE INVENTION

This invention relates generally to improvements in deformable grips for attachment to various products, and, as in one preferred embodiment, to writing instruments with deformable grips.

Deformable grips have been known for years on various products, such as manual implements and luggage. For example, such grips are shown in U.S. Pat. Nos. 4,364,150 and 5,000,599. While the deformable grips shown in these patents are generally acceptable, these grips are intended for a specific type or types of products and are not readily removed for use as grips on other products.

One writing instrument has a conventional formable grip. The grip is located around the body of the writing instrument, adjacent to its writing end. The grip has a tubular outer membrane and a tubular metal inner sleeve mounted in a concentric relationship. The inner sleeve is rigid. Circular flanges at both ends of the grip mechanically clamp the each end of the outer membrane to a corresponding end of the metal sleeve, thereby creating an internal cavity in the space between the concentrically-mounted membrane and metal sleeve. A formable polymer is located in the cavity, between the membrane and the metal sleeve. While the grip on this writing instrument is generally acceptable, the metal sleeve, membrane and flanges are relatively expensive to build and assemble. Due to the nature of the polymer materials used in the deformable grip, it is likely to need replacement after a period of time, which can in some cases be less than a year. However, the grip is not easily removed and replaced.

Accordingly, there has existed a need for an inexpensive deformable grip that can be configured for easier attachment to many types of products. The present invention satisfies this need.

### SUMMARY OF THE INVENTION

The present invention provides an inexpensive deformable sleeve that can be configured for attachment to many types of products as a grip or to provide a stylish appearance for the product. As shown by example in the numerous detailed embodiments described below the description of the drawings, the sleeve can be mounted on many products and on any product that has a portion capable of receiving a tubular sleeve.

In particular, the deformable sleeve of the invention includes a closed cell constructed of a membrane encapsulating a formable material. The deformable sleeve features two membranes that define a cavity filled with a formable material. The deformation of the sleeve resulting from the displacement or deformation of the formable material provides greater comfort for the user where the sleeve is mounted on products that are manually manipulated or are otherwise contacted by the user. A fundamental advantage of the sleeve is that it can be configured for easy attachment to many different devices, such as writing instruments, tennis racquets, eyeglasses, and other products having one or more portions shaped to accept the sleeve.

By way of example only, one preferred embodiment according to the invention provides a deformable sleeve for attachment to a product component. The sleeve includes a first tubular membrane. This membrane may be flexible or non-flexible. The first membrane has a radially outer surface of a predetermined width and a radially inner surface. The radially inner surface defines two openings and a passage of a predetermined size between the openings. The sleeve also has a second flexible tubular membrane that has a width greater than the width of the first membrane. The second membrane is located about the first membrane to cooperatively form a cavity between the first and the second membranes and a formable material is located in the cavity.

In a detailed embodiment, the first and second membranes may be formed of one piece of material. This piece of material may be a flexible tubular member folded in on itself from a first position to a second position to define the first and second membranes. In the first position, the tubular member defines a first opening, a second opening, and a passageway therebetween. Forming the sleeve from one piece of material advantageously reduces the cost of manufacturing and assembling the sleeve.

In yet more detailed embodiments, the tubular member may have different configurations, including a configuration where in the first position the member defines a first tubular section and a second tubular section. When the tubular member is in its first position, the first tubular section extends from the first opening of the member to a predetermined location. The second tubular section extends from this predetermined location to the second opening of the tubular member. The widths of the tubular sections differ so that one of the tubular sections can be folded toward the other section to form the cavity for the viscous material. In this regard, the first tubular section may have a width larger than the width of the second tubular section.

In yet more detailed embodiments, the tubular sections can have a generally cylindrical shape. Additionally, some or all of the sleeve components can be made with a material that includes aluminum oxide. The aluminum oxide increases the durability of the sleeve in applications where the sleeve encounters elevated temperatures.

Yet another embodiment relates to a product having a deformable sleeve. The product has a portion shaped to accept the sleeve thereon. The same detailed features described above may also be incorporated into the product.

Other features and advantages of the catheter assembly will become apparent from the following detailed description, taken in conjunction with the accompanying drawings, which illustrate, by way of example, the principles of the invention.

### BRIEF DESCRIPTION OF THE DRAWINGS

FIG. 1 is a perspective view of a first embodiment of a deformable patch according to the present invention;

FIG. 2 is a cross-sectional view of the deformable patch of FIG. 1;

FIG. 2A is a cross-sectional view of the deformable patch of FIG. 1, showing a user's finger deforming the patch;

FIG. 3 is a cross-sectional view of the deformable patch depicted in FIG. 2, taken in the direction of lines 3-3;

FIG. 3A is a cross-sectional view of an alternative design of the patch of FIG. 3;

FIG. 4 is a cross-sectional view of an alternative design of the patch of FIG. 3;

FIG. 4A is a cross-sectional view of an alternative design of the patch of FIG. 4;

FIG. 5 is a perspective view of another embodiment of a deformable sleeve according to the present invention;

FIG. 6 is a cross sectional view of the deformable sleeve of FIG. 5, taken in the direction of lines 6-6;

FIG. 7A is a cross sectional view of the deformable sleeve of FIG. 6, taken in the direction of lines 7A-7A;

FIG. 7B is a cross sectional view of the deformable sleeve of FIG. 7A, shown in an unassembled condition;

FIG. 8 is a perspective view of the deformable sleeve of FIG. 5, shown on a ball point writing instrument;

FIG. 9 is a perspective view of the deformable sleeve of FIG. 5, shown on a pencil writing instrument;

FIG. 10 is an elevational view of a golf club with a deformable patch, according to another embodiment of the present invention;

FIG. 11 is a detail view of the golf club grip, taken from area 111 of FIG. 10;

FIG. 12 is an elevational view of a hockey stick with a deformable patch, according to another embodiment of the present invention;

FIG. 13 is a detail view of the hockey stick grip, taken from area 13 of FIG. 10;

FIG. 14 is a perspective view of a tennis racquet with a deformable patch, according to another embodiment of the present invention;

FIG. 15 is a perspective view of a paint brush with deformable patches, according to another embodiment of the present invention;

FIG. 16 is a perspective view of binoculars with deformable patches, according to another embodiment of the present invention;

FIG. 17 is an elevational view of a saw with a deformable patch, according to another embodiment of the present invention,

FIG. 18 is a perspective view of a tape measure with the deformable patch of FIG. 1 thereon;

FIG. 19 is a perspective view of a shovel with deformable patches, according to another embodiment of the present invention;

FIG. 20 is a perspective view of a faucet with deformable patches, according to another embodiment of the present invention;

FIG. 21 is a perspective view of a door knob with a deformable patch, according to another embodiment of the present invention;

FIG. 22 is a perspective view of a weed trimmer with deformable patches, according to another embodiment of the present invention;

FIG. 23 is a perspective view of a lawn mower with a deformable patch, according to another embodiment of the present invention;

FIG. 24 is a perspective view of a vacuum cleaner with a deformable patch, according to another embodiment of the present invention;

FIG. 25 is a perspective view of a chair with deformable patches, according to another embodiment of the present invention;

FIG. 26 is an elevational view of a knife with deformable patches, according to another embodiment of the present invention;

FIG. 27 is an elevational view of a spatula with deformable patches, according to another embodiment of the present invention;

FIG. 28 is a perspective view of a cooking pot with deformable patches, according to another embodiment of the present invention;

FIG. 29 is a perspective view of a pan with a deformable patch, according to another embodiment of the present invention;

FIG. 30 is a perspective view of a laundry machine with deformable patches on its control dial, according to another embodiment of the present invention;

FIG. 31 is a detail perspective view of the control dial from the machine of FIG. 30;

FIG. 32 is a perspective view of a remote control with deformable patches, according to another embodiment of the present invention;

FIG. 33 is a perspective view of an audio receiver with deformable patches, according to another embodiment of the present invention;

FIG. 34 is an elevational view of a telephone with deformable patches, according to another embodiment of the present invention;

FIG. 35 is a perspective view of a personal digital assistant with deformable patches, according to another embodiment of the present invention;

FIG. 36 is a perspective view of a pager with a deformable patch, according to another embodiment of the present invention;

FIG. 37 is a perspective view of a telephone handset with deformable patches, according to another embodiment of the present invention;

FIG. 38 is a perspective view of a joystick with a deformable patch, according to another embodiment of the present invention;

FIG. 39 is a perspective view of a computer mouse with a deformable patch, according to another embodiment of the present invention;

FIG. 40 is a perspective view of a letter opener with a deformable patch, according to another embodiment of the present invention;

FIG. 40A is a perspective view of eyeglasses with deformable patches, according to another embodiment of the present invention;

FIG. 41 is a perspective view of a firearm with deformable patches, according to another embodiment of the present invention;

FIG. 42 is a perspective view of a stapler with a deformable patch, according to another embodiment of the present invention;

FIG. 43 is a perspective view of scissors with deformable patches, according to another embodiment of the present invention;

FIG. 44 is a perspective view of a clipper with a deformable patch, according to another embodiment of the present invention;

FIG. 45 is a perspective view of tweezers with deformable patches, according to another embodiment of the present invention;

FIG. 46 is a perspective view of a toothbrush with a deformable patch, according to another embodiment of the present invention;

FIG. 47 is a perspective view of a blow dryer with a deformable patch, according to another embodiment of the present invention;

FIG. 48 is a perspective view of an automotive interior with deformable patches, according to another embodiment of the present invention;

FIG. 49 is a perspective view of a glove with deformable patches, according to another embodiment of the present invention;

FIG. 50 is a perspective view of a protective guard with a deformable portion, according to another embodiment of the present invention;

FIG. 51 is a perspective view of another protective guard with a deformable portion, according to another embodiment of the present invention;

FIG. 52 is a perspective view of a helmet with a deformable portion, according to another embodiment of the present invention;

FIG. 53 is a perspective view of bicycle handlebars with deformable patches, according to another embodiment of the present invention;

FIG. 54 is a perspective view of a bicycle seat with a deformable portion, according to another embodiment of the present invention;

FIG. 55 is a perspective view of a cup with a deformable patch, according to another embodiment of the present invention;

FIG. 56 is a perspective view of a mug with a deformable patch, according to another embodiment of the present invention;

FIG. 57 is a perspective view of a deformable mouthguard according to another embodiment of the present invention;

FIG. 58 is a perspective view of a camera with a deformable patch, according to another embodiment of the present invention;

FIG. 59 is a perspective view of a dental pick with a deformable patch, according to another embodiment of the present invention;

FIG. 60 is a perspective view of a hammer with a deformable patch, according to another embodiment of the present invention;

FIG. 61 is a plan view of a deformable patch, according to another embodiment of the present invention;

FIG. 62 is a cross sectional view of the deformable patch of FIG. 3A, shown attached to a product;

FIG. 63 is a detailed cross sectional view of the deformable patch according to another embodiment of the present invention;

FIG. 64 is a detailed cross sectional view of the deformable patch according to another embodiment of the present invention;

FIG. 65 is a detailed cross sectional view of the deformable patch according to another embodiment of the present invention;

FIG. 66 is a detailed cross sectional view of the deformable patch according to another embodiment of the present invention;

FIG. 68 is a cross section of an alternative embodiment of the deformable steering wheel grip of FIG. 48; and

FIG. 69 is an elevational view of the deformable steering wheel grip of FIG. 68.

### DETAILED DESCRIPTION OF THE PREFERRED EMBODIMENT

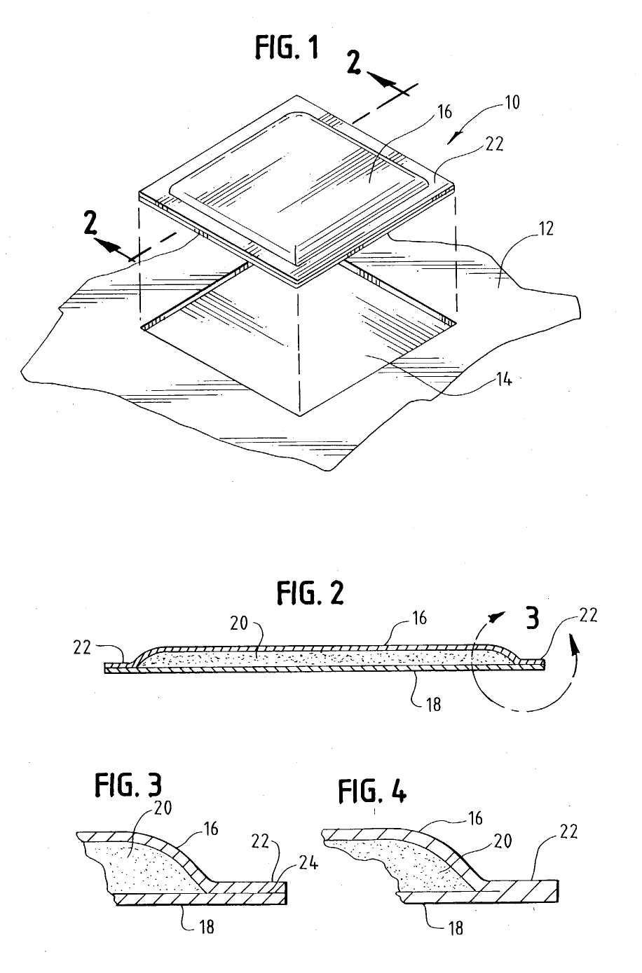

Referring now to FIG. 1 of the drawings, one embodiment of the invention is a rectangular patch, or grip, indicated by the reference numeral 10, for attachment to the surface 12 of a product, in an area 14 where the product will be touched by a person or gripped or manipulated by a person's hands or fingers. For example, the area 14 where the grip 10 is attached may be on the grip area of a pair of binoculars (FIG. 16) or other optical device, such as a camera (FIG. 58), a telescope, or a monocular. It should be appreciated that embodiments of the patch can be made in any shape and can provide advantages in the manufacture and/or use of all types of products. For example, the shape of the patch can be contoured or shaped to correspond to a particular area of the users body that will contact the grip. The patch can be provided in a flat shape or a tubular shape, as described below. The patch likewise can be applied to a product to provide for a stylish appearance, even in areas where contact with a user is unlikely or infrequent. Depending on the product to which the patch is attached, the area 14 where the patch is attached may or may not be indented. It should be appreciated that flat or sleeve type patches can be used interchangeably where both will fit on a particular area of a product.

The patch 10 preferably is deformable so that it will closely conform to the fingers of different users. In other applications, the patch also will conform to other parts of a user's body that contact the patch. If the patch is reformable, it is configured to resume its original shape after deformation. In particular, the patch can be deformed and hold its deformed shape for at least 5 seconds before slowly returning to its original shape. Depending on the materials used, the patch may take much longer to return to its original shape or it may stay in its deformed shape. In one embodiment, the patch deforms and will not return to its original shape for 10-60 seconds.

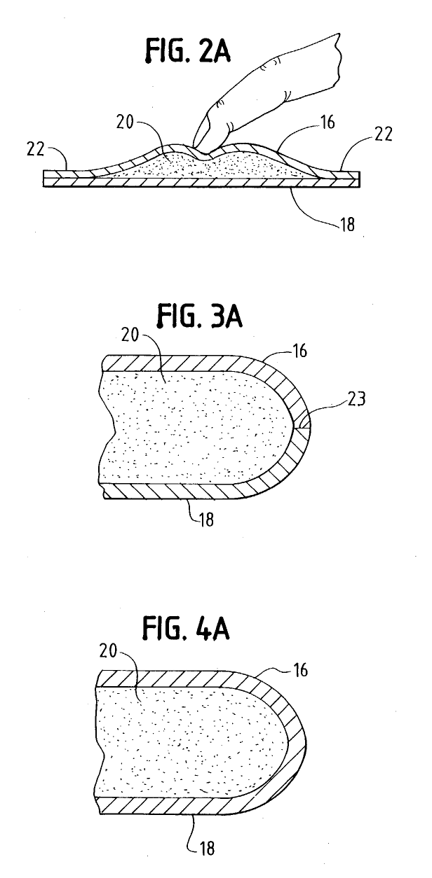

By conforming to the fingers of a user, the patch more evenly distributes pressure and force across the surface of the user's fingers, thereby reducing stress and fatigue and increasing the comfort of the user. One such example is illustrated in FIG. 2A. In other applications, the patch can deform from contact with other parts of the user's body, thereby evenly distributing the force of such contact over a larger area to make such contact more comfortable to the user. The patch can be permanent or temporary and can be easily removed and replaced in applications where such removal and replacement is advantageous.

As shown in FIG. 2, the deformable patch 10 is closed cell having an upper membrane 16 and a base 18 that encapsulate a formable material 20. The upper membrane 16 and base 18 of the patch 10 may have rectangular or square shapes. The side edges of the upper membrane 16 are bonded to the side edges of the base 18, thereby creating a flat edge portion 22 around the patch and a cavity between the membrane and the base. The cavity is filled with the formable material thicknesses may be appropriate depending on the materials used and the requirements of a particular application.

As shown in FIG. 3, the an adhesive can be placed on area 24, between the edges 22 of the upper membrane 16 and the base 18, to bond the base to the membrane. If a glue is used, the formable material 20 would be placed on the central portion of the base 18 and glue would be applied to the edges of the base. The upper membrane can then be placed over the formable material so that the edges of the upper membrane align with the edges of the base and pressure can be applied until the glue cures to bond the membrane 16 to the base 18. Such pressure can be applied by a mold, a press, or by hand. If the base and membrane edges do not align, they can be trimmed or cut after the membrane is bonded to the base.

Alternatively, as shown in FIG. 4, raw uncatalyzed material can be applied to the area 24 between the side edges 22 of the membrane 16 and base 18. The membrane 16 and base 18 then can be joined in a press and heated to activate the catalyst to bond the membrane to the base and melt the materials together. If a press is used, the formable material 20 would be placed on the base 18 and then the upper membrane would be placed over the formable material. The press would then be operated to apply pressure and heat to form the patch 10. The membrane 16 and the base 18 may alternatively be formed of uncatalyzed material that is heated in a press until it is in a final, catalyzed state.

As shown in FIGS. 3A and 4A, the patch 10 alternatively need not have a flat edge portion 22, depending on the requirements of a particular application. The edge areas 23 of the membrane 16 and the base 18 can be bonded, as shown in FIG. 3A. Alternatively, the membrane 16 can be melted to the base 18, as shown in FIG. 4A. The patch's edge portion 22 also could be configured as multiple tabs projecting away from the patch. Further, depending on the application, the edge portion 22 may be minimized or the upper membrane 16 may be wrapped under the base 18 so as to eliminate the edge portion 22. 20 to facilitate the deformation of the patch 10 by the displacement of the formable material by a user's fingers or through other contact.

The formable material 20 can be viscous and can include silicone-based polymers, gels, vinyl elastomers, or any other material of sufficient properties to allow the deformation of the patch 10 from user contact. Materials can also be used to provide a slow reformation of the original patch shape after it has been deformed and released. In this regard, a silicone gel or other non-cross-linked polymer or uncatalyzed materials may be used. It should be appreciated that the composition of the formable material could be altered for applications in which varied patch characteristics are desired (i.e. more stiffness, durability, more or less deformability and/or longer-lasting deformation). The formable material may be elastically deformed or it may be deformed by displacement, which is the actual movement or flow of the material in response to pressure, such as that from a user's fingertips. In addition, the formable material could be altered for applications in which varied temperature conditions would be encountered during the use of particular products on which the patch is mounted.

The base 18 can be made of any material, rigid or elastic, including various plastic or metal materials, or it can be made of a membrane formed of thin rubber-based material, deformable plastic or silicone-based materials or other elastomeric materials suitable for a given application. If the base is configured as a flexible membrane, the patch can more easily conform to the product's surface 14, thereby increasing the ease with which the patch can be installed, removed, and replaced. Likewise, the upper membrane 16 also can be made of a thin rubber-based material, deformable plastic or silicone polymer materials, or other elastomeric materials suitable for a given application. If the base and membrane are made of silicone material, both should be from 0.50 mm to 2.5 mm in thickness. In this regard, the base may be a membrane instead of a piece of rigid material. Other

While the way of joining the base 18 with product patch area 14 the membrane can vary depending on the particular application, adhesives can be used on some or all of the bottom surface of the base 18 or on some or all of the edge portion of the base 18. Likewise, some or all of the bottom surface of the base 18 or some or all of the edge portion 22 can be mechanically fastened or clamped to the product patch area 14. Adhesive tape or a combination of adhesive and mechanical attachment also could be used.

In applications where the patch 10 is attached to a product by an adhesive, various types of adhesives can be used depending on the type of product surface and the type of base material used. For example, if the base material 18 of the patch is a silicone polymer, then cyanoacrylate glue or 3M Super Silicone brand sealant can be used. In another example, if the product surface 14 is a thermoplastic material and the base material 18 of the patch is a polyethylene plastic material, then cyanoacrylate glue or 3M Super Silicone brand sealant can be used.

One type of adhesive that may be used is 3M brand Super silicone sealant, which is a one-component, paste-like material that cures to a tough, elastomeric solid when exposed to atmospheric moisture. This sealant will adhere to clean, bare, or painted metal, glass, non-oily wood, abraded rubber and many types of plastics. The sealant is a one-part vulcanizing silicone rubber type having the consistency of a non-sagging paste. It is made of 100% solids and has a net weight of approximately 8.3-8.7 pounds per gallon. This sealant is available in clear, white or black colors. The sealant can be extruded from an 0.125 inch orifice using a pressure of ninety pounds per square inch. Such extrusion results in a flow of approximately 350 gallons per minute.

The silicone sealant is of an acetoxy cure type. In particular, upon exposure to moisture, the silicone sealant will give off small amounts of acetic acid while the sealant cures. It is not recommended that the acetic acid vapors be inhaled. The sealant will cure in 24 hours and has a tack free time of 10-20 minutes at 77° F. (25° C.) with 50% relative humidity. The sealant's tensile strength is approximately 350 psi, its elongation property is 450%, and its hardness is approximately 25-30 Shore A. The sealant has temperature stability from −85° F. to 450° F. (−65° C. to 232° C.) and can withstand intermittent exposure to temperatures as high as 500° F. (280° C.). The sealant is believed to have good resistance to various weathering conditions, including UV radiation, rain, snow, etc, without hardening, cracking, or shrinking.

For optimum adhesion with the above adhesive, the product surface 14 and the lower surface of the base 18 should be clean, dry, and free from oil, grease or other foreign material. If necessary, metal surfaces should be wiped with a non-oily solvent. Rubber surfaces should be abraded to promote adhesion. Depending on environmental conditions, the base and product surface should be joined within 5-10 minutes, before the tack-free time of the sealant passes.

The patch 10 can be used on various products that are manipulated by a user's hands or fingers. For example, FIGS. 10 and 11 show the patch 10 attached to the handle 26 of a golf club 28. In this example, the patch 10 is long and narrow, thereby allowing it to wrap around the handle of the golfclub. The deformable nature of the patch allows the handle of the golf club to closely conform to the hands of the user for a more comfortable grip. The patch can be used on other sports clubs, and, in particular, on the handle 30 of a hockey stick 32 or on the handle 34 of a tennis racquet 36, as shown in FIGS. 12, 13, and 14. As shown in FIG. 13, the patch 10 is wrapped around the handle 32 of the hockey stick 32. The patch 10 on the tennis racquet 36 allows the handle 34 to closely conform to the hands of the user for a more comfortable grip. The patch 10 is attached to the handle 34 of the tennis racquet 36 in a manner similar to that shown in FIG. 13.

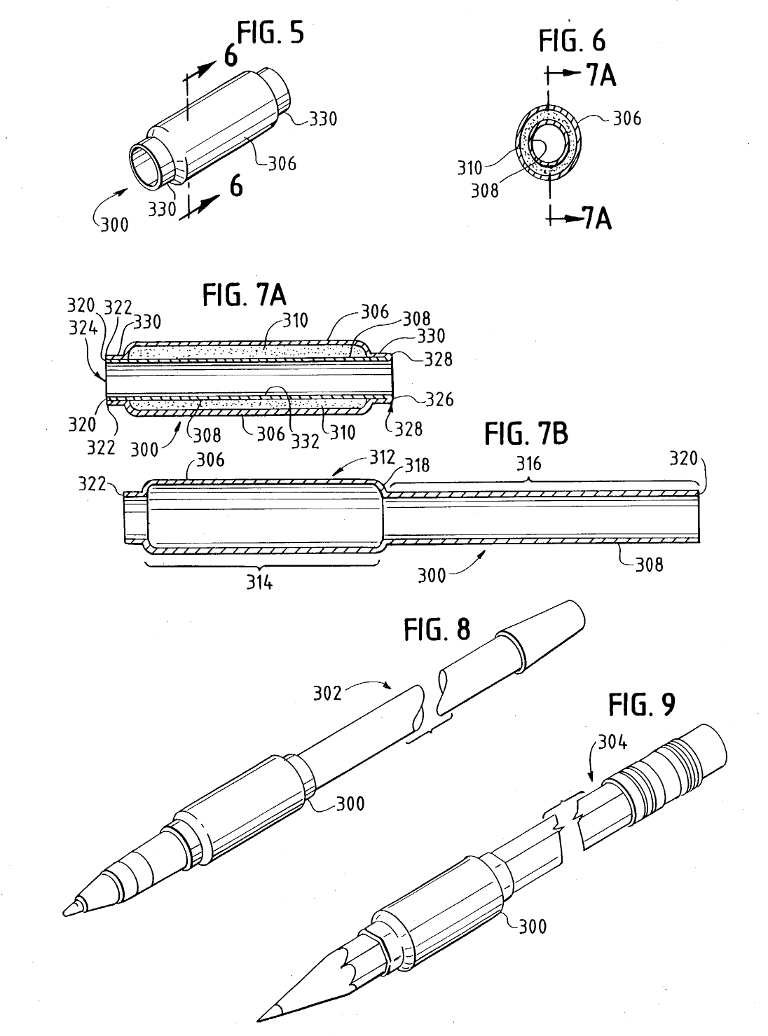

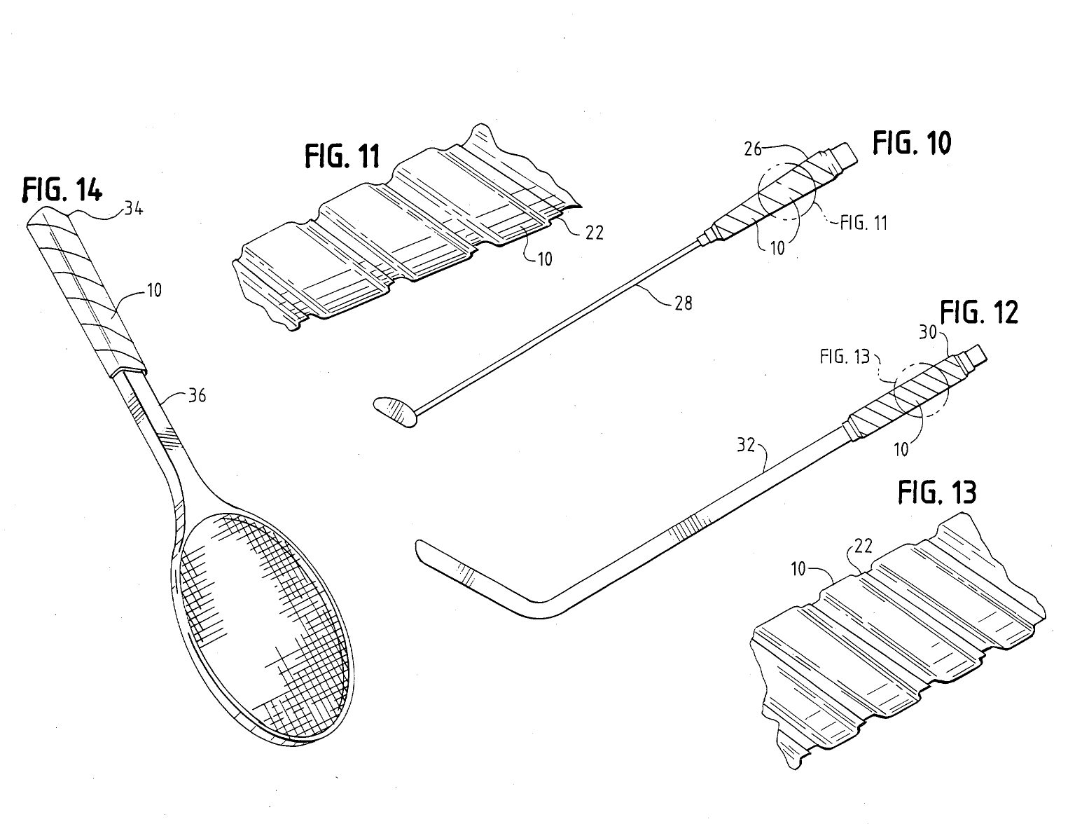

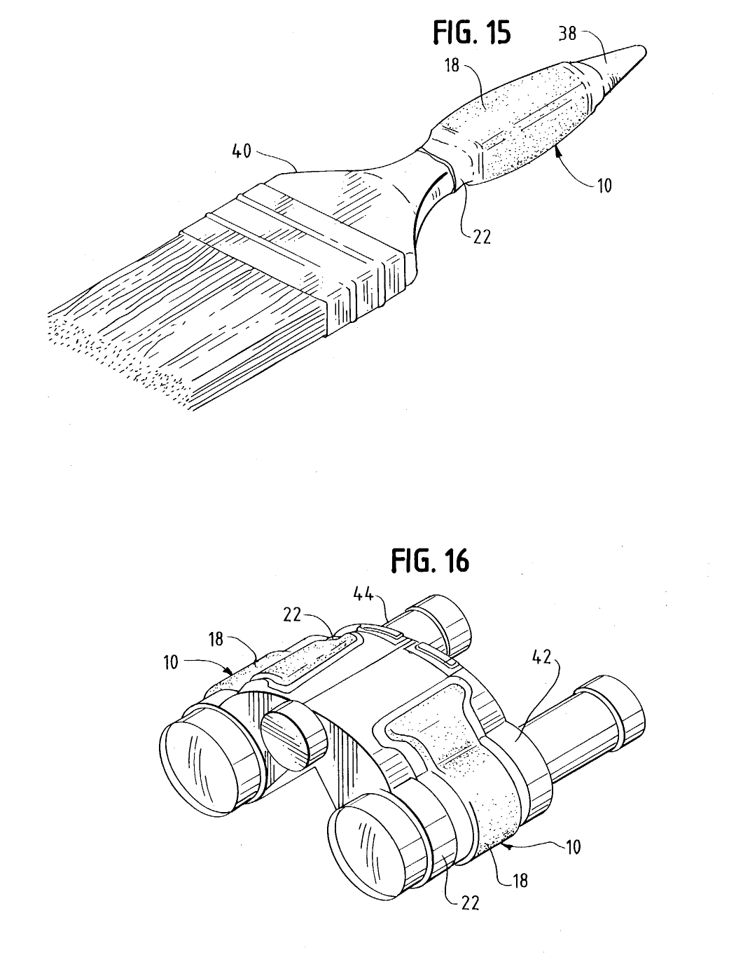

Before proceeding with additional descriptions of the products that incorporate the patch 10, it should be appreciated that FIG. 5 shows another embodiment of the patch 300 having a sleeve-type configuration (described below) that can in most cases be used instead of the patch 10. Accordingly, were a patch is referred to by reference number 10 and a patch 300 will fit on a particular product, the reference number is intended to refer to both types of patches, and visa versa.

FIG. 15 shows the patch 10 attached to the handle 38 of a paint brush type painting device 40. In this example, the patch 10 is sized to wrap around the handle of the paint brush. The deformable nature of the patch allows the handle of the painting device to closely conform to the hands of different users for a more comfortable grip. It should be appreciated that the patch can be configured to attach to any type of hand-held painting device, such as roller handles, paint gun handles, or the brush-type device 40 shown in FIG. 15.

FIG. 16 shows the patch 10 attached to the housing 42 of a binocular 44. In this example, the patch 10 is sized to wrap around the handle of the painting implement. The deformable nature of the patch allows the handle of the binocular to closely conform to the hands of different users for a more comfortable grip. It should be appreciated that the patch 10 can be configured to attach to any type of hand-manipulated optical device, such as a telescope, a monocular, or various types of cameras, including 35 mm film cameras, digital cameras, and video cameras.

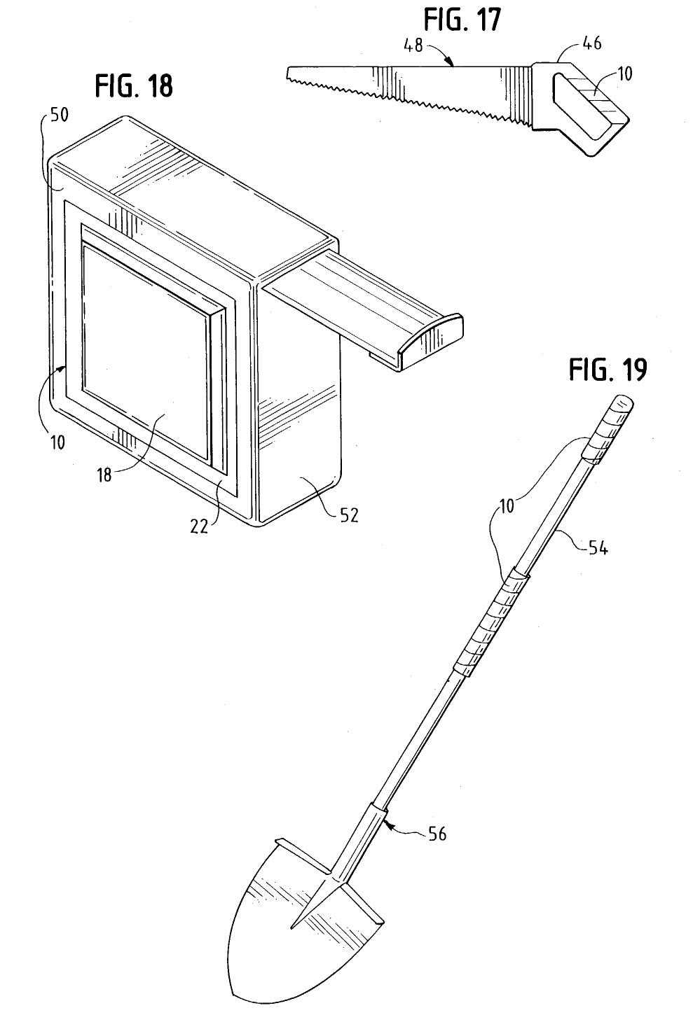

As shown in FIGS. 17-19, the patch 10 can be configured to attach to various tools that are manipulated by hand. For example, the patch 10 can be sized to wrap around the handle 46 of a saw 48. The deformable nature of the patch allows the handle of the saw to closely conform to the hands of different users for a more comfortable grip. The patch 10 can be sized to attach to one or both of the side walls 50 of a tape measure housing 52. The housing encloses a mechanical tape measure mechanism, but also can enclose an electronic or optical measurement system. The deformable nature of the patch allows the tape measure to closely conform to the hands of different users for a more comfortable grip. The patch 10 can be sized to wrap around the handle 54 connected to a shovel head 56. The deformable nature of the patch allows the handle of the shovel to closely conform to the hands of different users for a more comfortable grip. The patch 10 can be attached in one or more locations on the shovel handle 54. Alternatively, a rake head, a hoe head or a broom head with a brush can be substituted for the shovel head 56. The patch 10 can be attached to the handles of the saw 48 and the shovel 56 in a manner similar to that shown in FIG. 13. It should be appreciated that the patch 10 can be configured to attach to any type of hand-manipulated tools, such as rakes, hoes, hedge trimmers, power saws, drills, hammers, or other types of tools.

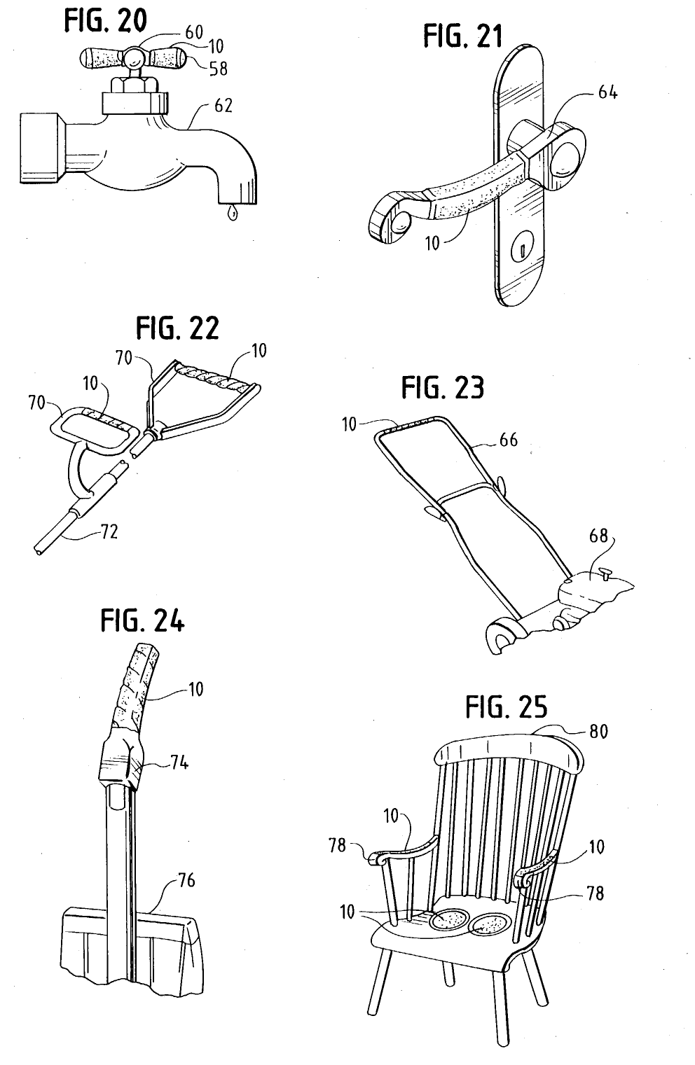

Additional products that incorporate the patch 10 are shown in FIGS. 20-25. In particular, the patch 10 can be sized to wrap around the spokes 58 of a handle 60 on a faucet 62. The deformable nature of the patch allows the handle of the faucet to closely conform to the fingers of different users for a more comfortable grip. The patch 10 also can be sized to wrap around a door knob 64. The deformable nature of the patch allows the door knob to closely conform to the hands of different users for a more comfortable grip. The patch 10 also can be sized to wrap around the handle 66 of a lawn mower 68 or the handle 70 of a weed trimmer 72. The patch 10 can be attached to the handles of the lawn mower 68 or the weed trimmer 72 in a manner similar to that shown in FIG. 13. The deformable nature of the patch allows the handles of the lawn mower 68 and the weed trimmer 72 to closely conform to the hands of different users for a more comfortable grip. The patch 10 can be attached in one or more locations on the weed trimmer handle 70.

The patch 10 also can be attached to the handle 74 of a vacuum cleaner 76. For this application, the patch is wrapped around the vacuum cleaner handle 74 in a manner similar to that shown in FIG. 13. The patch can be mounted on the handles of other floor cleaning devices, including steam cleaners, floor polishers and carpet shampoo machines. The patch also can be attached to the armrests 78 of a chair 80 to provide a comfortable area for a user to rest his or her arms.

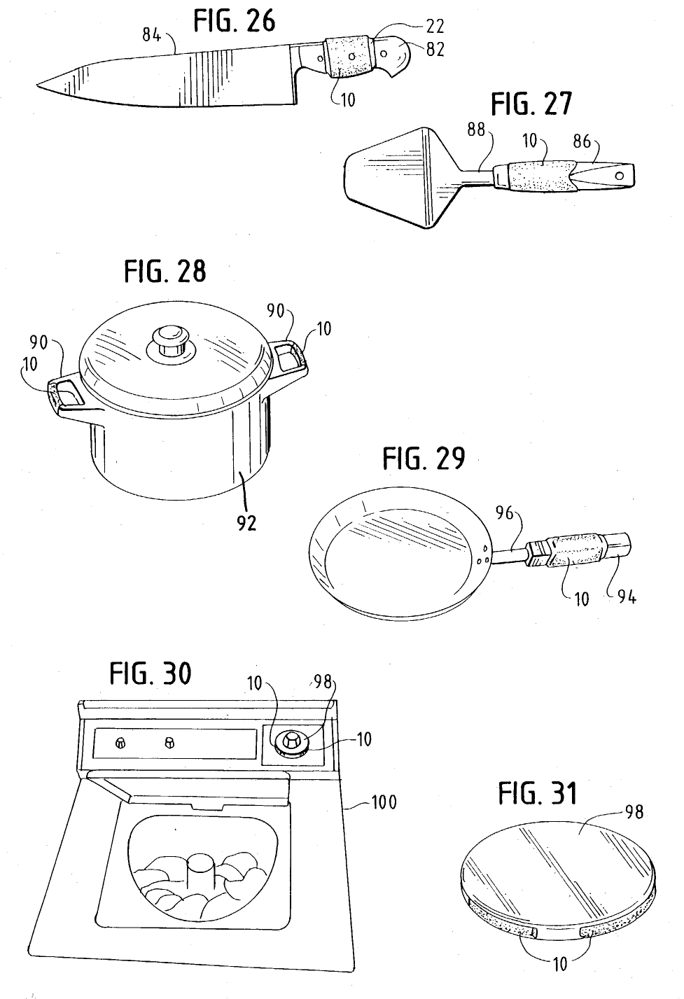

Additional products that can incorporate the patch 10 are shown in FIGS. 26-31. In particular, the patch 10 can be sized to attach to the handle 82 on a kitchen knife 84 or to the handle 86 of a spatula 88. The patch 10 also can be sized to wrap around one or more handles 90 of a pot 92 or the handle 94 of a pan 96. It should be appreciated that the patch can be applied to other types of cookware and bakeware. For high-temperature applications where the patch components are made of silicone materials, aluminum oxide may be added to the membrane 16, base 18, and/or the formable material 20 so that the patch will survive such elevated temperatures. The aluminum oxide additive may be a 99.99% aluminum oxide sold by the Alfa Aesar company under stock number 39815. Alternatively, other additives may be used to provide durability at higher temperatures, as may be required by a particular application. The patch also can be attached to the dial 98 on a laundry cleaning machine 100, such as a washer or dryer. The deformable nature of the patch allows the handles and dial described above to closely conform to the hands of different users for a more comfortable grip.

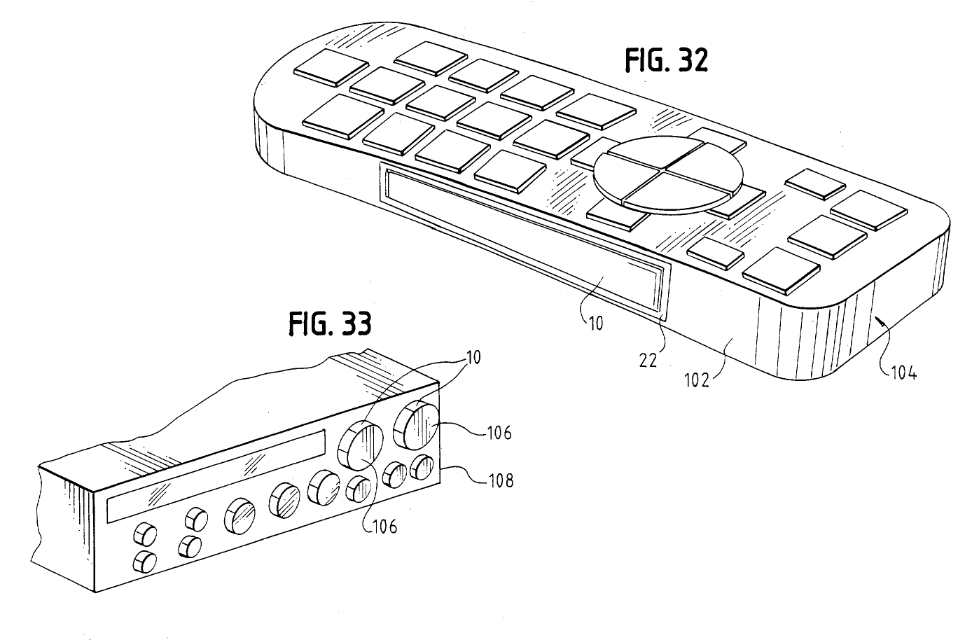

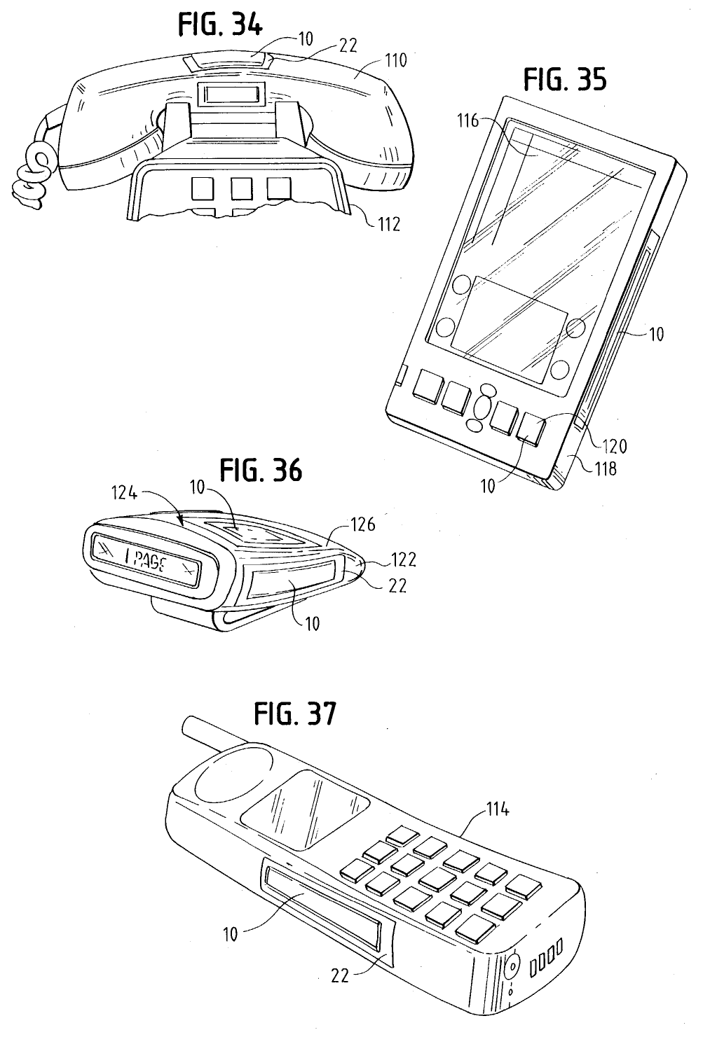

FIGS. 32-37 show electronic products that can incorporate the patch 10. In particular, the patch can be attached to the side 102 of a remote control 104. The patch also can be attached to buttons or knobs 106 on an audio player 108, such as an FM receiver or the like. The patch can be attached in one or more locations on the handset 110 of telephone 112, on a mobile phone 114, or on a personal digital assistant 116, including the sides and rear surfaces. As shown on the personal digital assistant 116 of FIG. 35, the patch 10 can be attached on the sides 118 of the digital assistant and/or over its buttons 120. The patch also can be attached to the sides 122 of a pager 124. The patch could also be attached to the back 126 of the pager.

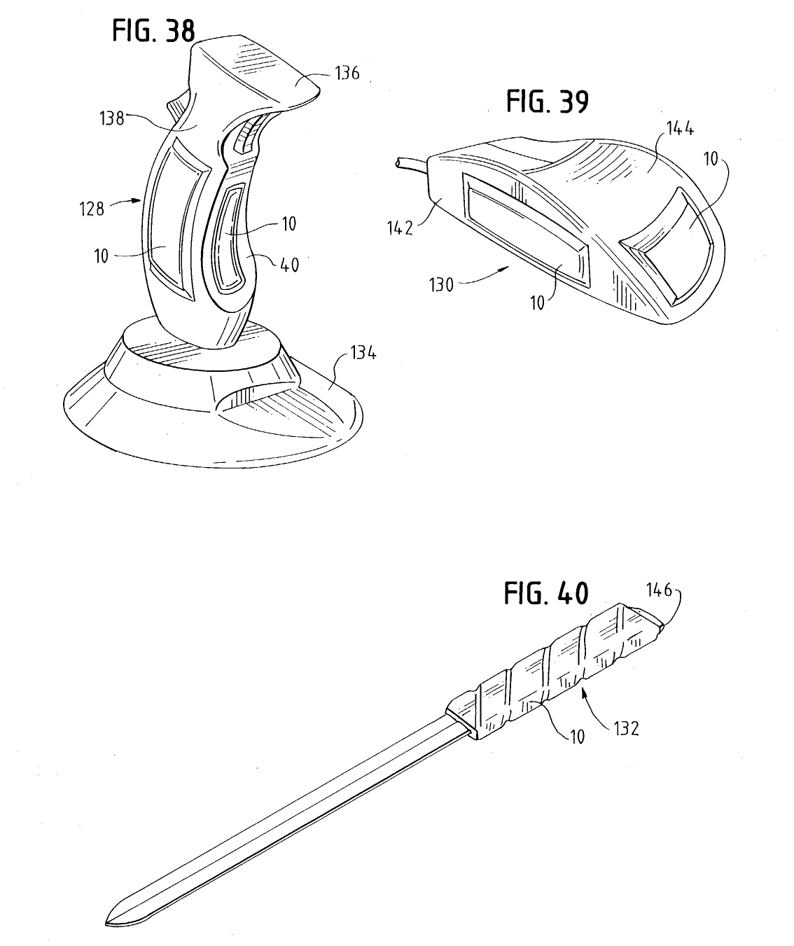

FIGS. 38-40 show additional products incorporating various-sized patches 10, including a joystick 128, a computer mouse 130 and a letter opener 132. The joystick has a base 134 and a pivotably mounted control stick 136. Patches can be mounted on one or more surfaces of the control stick, including the side surfaces 138 and/or the rear surface 140. Likewise, a patch can be mounted to the side and/or upper surfaces 142 and 144 of the computer mouse. The patch is mounted to the handle 146 of the letter opener in a manner similar to that shown in FIG. 13.

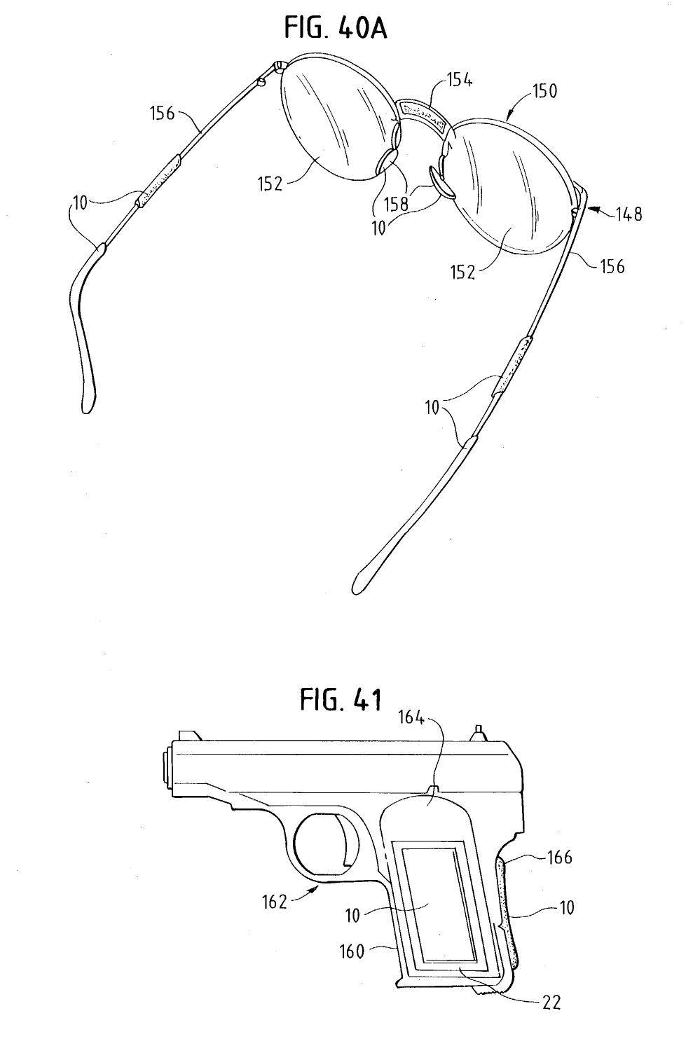

As shown in FIG. 40, the patch 10 can be attached to eyeglasses 148 to increase the comfort of the user. The eyeglasses have a main body 150 with lenses 152 and a bridge 154. Arms 156 extend back from the body to rest on the user's ears. Nose pads 158 extend downwardly from the body to rest on a user's nose. The patch can be sized for placement on the nose pads and/or the arms, near the area where the user's ears would contact the arms.

As shown in FIG. 41, one or more patches 10 can be attached to the handle 160 of a firearm 162. Patches can be mounted on one or more surfaces of the firearm handle, including on the side surfaces 164 and/or the rear surface 166. The patch on the rear surface of the firearm handle can cushion the user against recoil from firing the weapon.

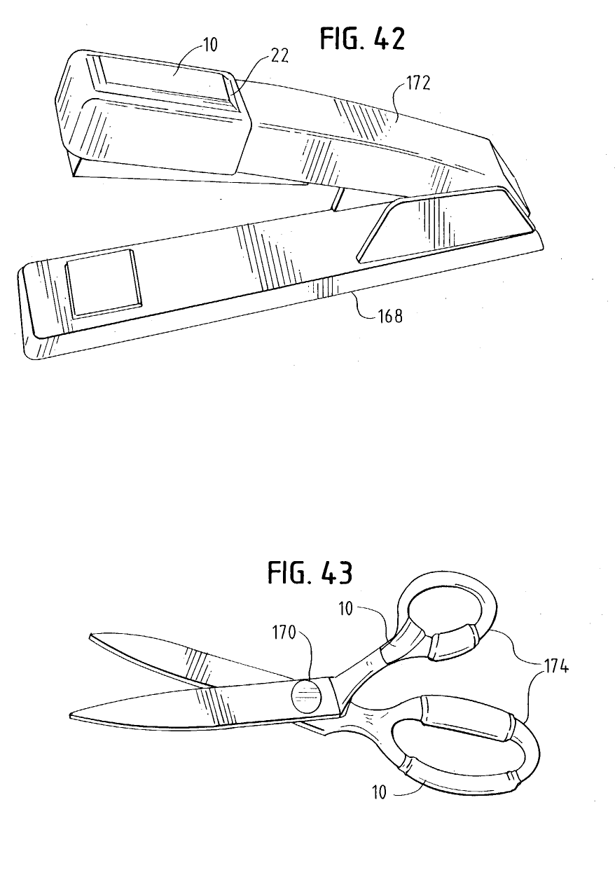

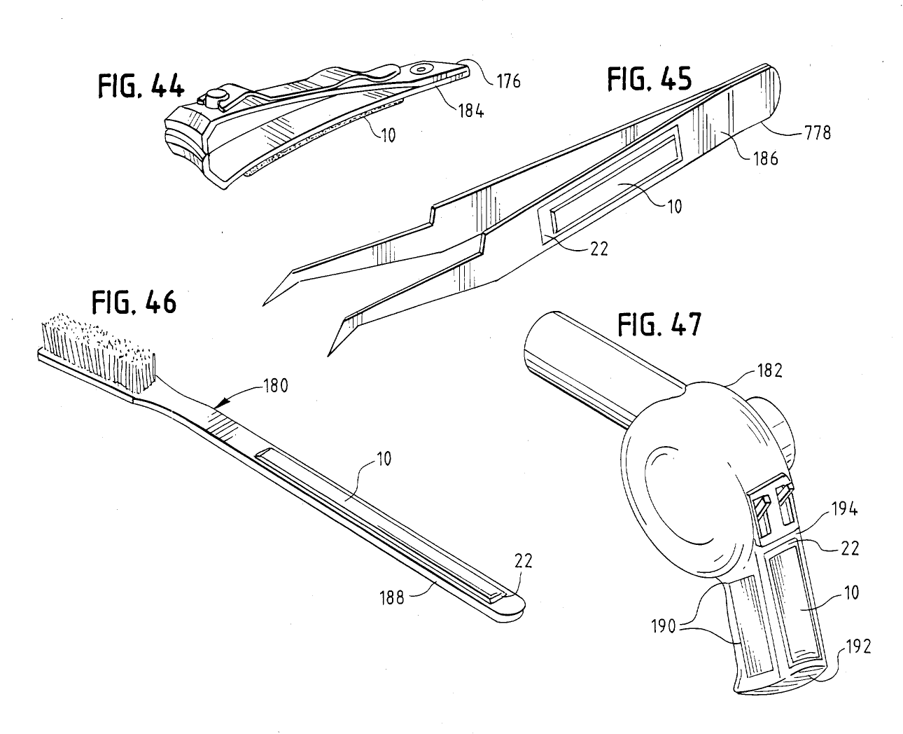

As shown in FIGS. 42 and 43, patches 10 of suitable sizes can be attached to office products, including on a stapler 168 and a scissors 170. A rectangular patch is mounted to the upper surface 172 of the stapler. One or more patches also can be mounted to the handles 174 of the scissors. Other products that incorporate patches 10 are shown in FIGS. 44-47, including clippers 176, tweezers 178, a toothbrush 180, and an electric hair dryer 182. With regard to the clippers, the patch is mounted to the lower surface 184. The patch is mounted to each side surface 186 of the tweezers. The patch can be mounted on one or more sides of the handle 188 of the toothbrush. The patch can be mounted on one or more sides 190 of the handle 192 of the electric hair dryer, and/or on its rear handle surface 194.

As shown in FIG. 48, patches 10 of suitable sizes can be attached to various parts of an automobile interior, including wrapped around a steering wheel 196, on a shifter 198, on an armrest 200. The patch also can be attached to a seat 202, and in particular on the seat back 204 and/or on the seat bottom 206. The patch can also be applied decoratively to other portions of the interior.

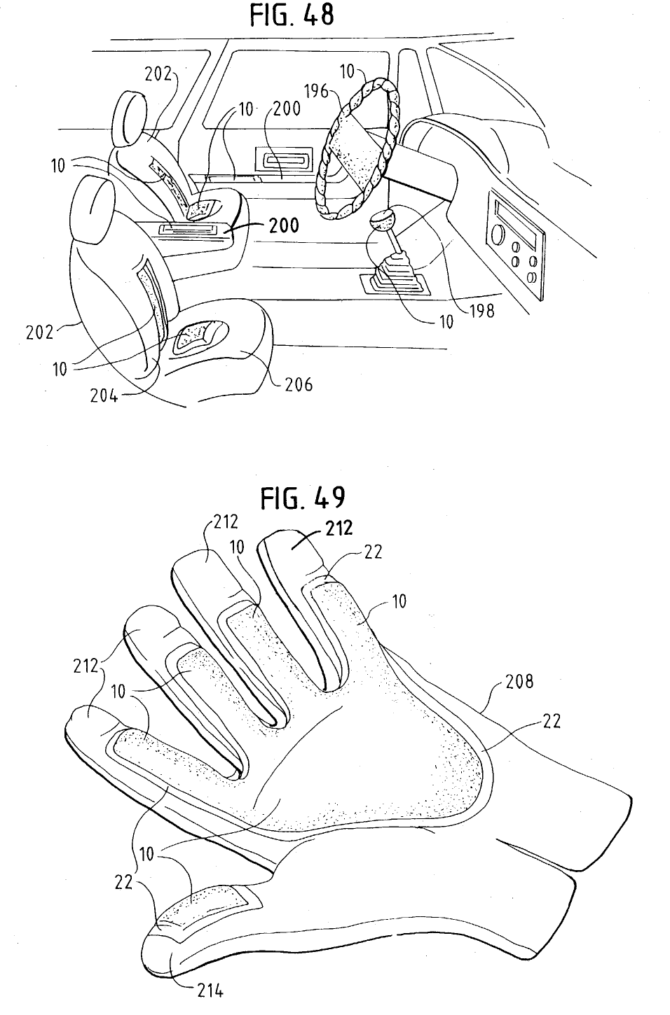

As shown in FIG. 49, one or more of the patches 10 can be attached to a glove 208. The glove has a palm portion 210 that includes a patch 10. The glove also has finger portions 212 that each include a patch 10. Finally, the glove has a thumb portion 214 that also includes a patch 10 mounted thereon.

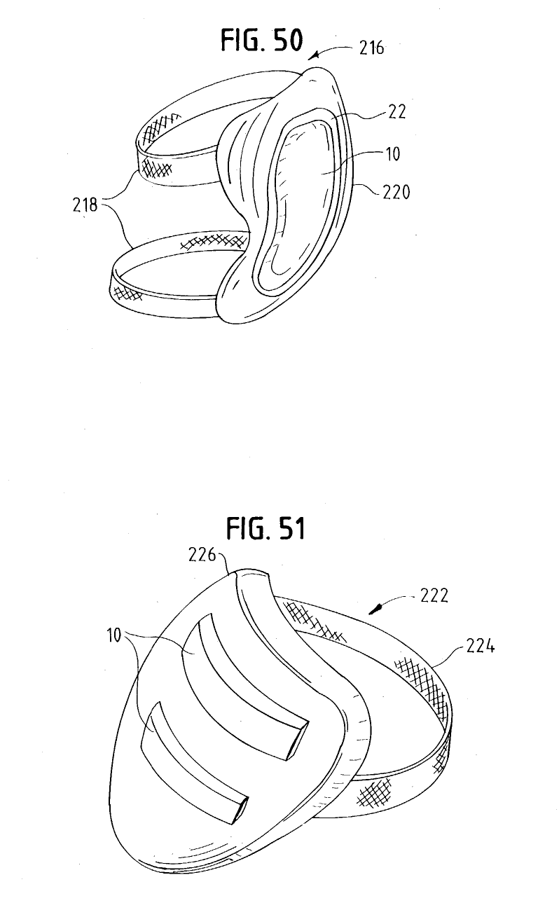

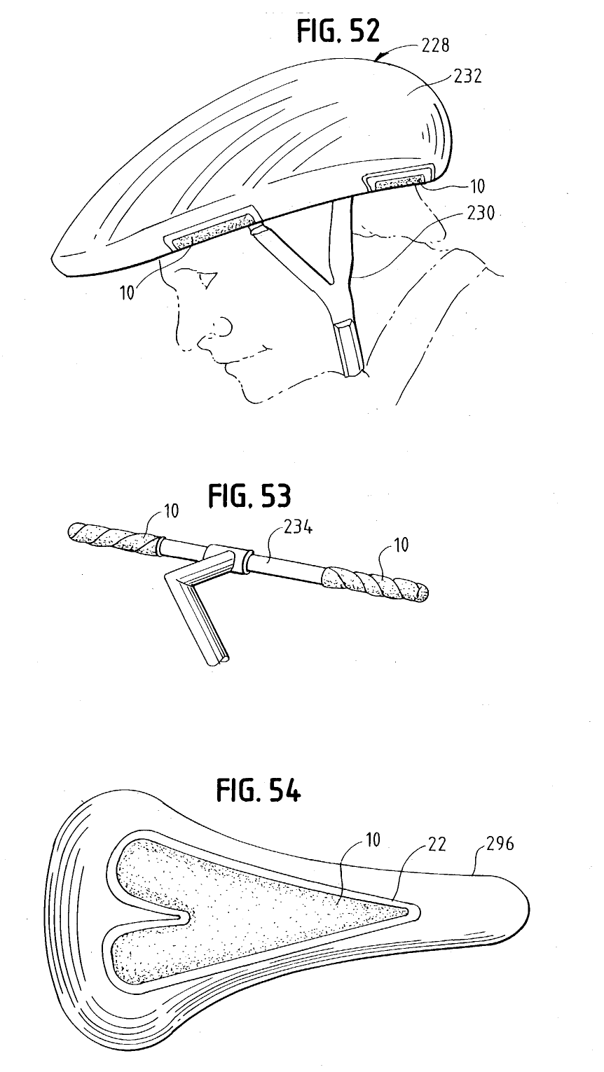

The patch 10 also can be used on safety equipment, as is shown in FIGS. 50-52. FIG. 50 shows an elbow guard 216 that has two straps 218 and a guard plate 220. The straps can be adjustable or elastic so as to fit over the arms of a user. The patch 10 is attached to the guard plate to cushion impacts. FIG. 51 shows a knee guard 222 that has a strap 224 and a guard plate 226. The patch 10 is mounted on the guard plate. The patch also can be used on shin guards. FIG. 52 shows a helmet 228 that has a strap 230 and a helmet body 232 and/or the strap. One or more patches 10 can be mounted to the helmet body. Examples of helmets that can be fitted with the patch are bicycle, motorcycle, football, baseball and hockey helmets. As shown in FIGS. 53 and 54, the patch 10 also can be attached to bicycle components. In particular, the patch can be mounted to bicycle handlebars 234 and/or a bicycle seat 236.

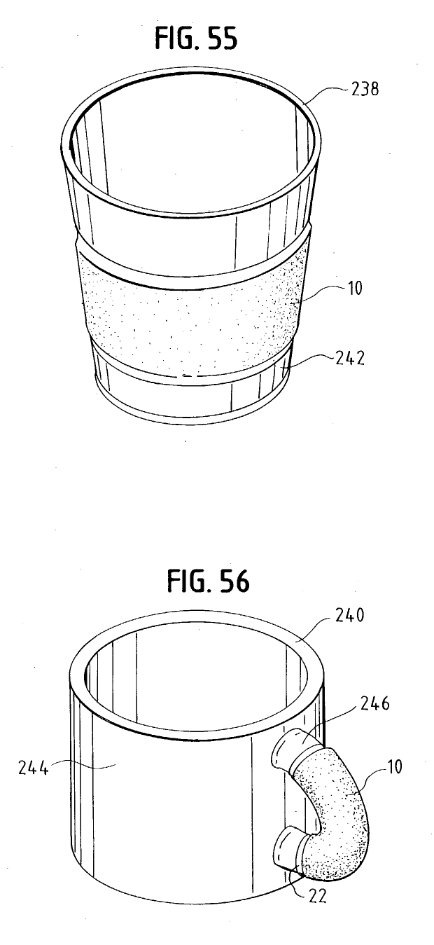

As shown in FIGS. 55 and 56, the patch can be attached to a cup 238 and/or mug 240. The cup 238 has a curved body with an exterior surface 242 to which one or more patches 10 can be attached. The patch may extend all the way around the exterior surface of the cup. Likewise, the mug 240 has a curved exterior surface 244 with a handle 246. Patch 10 is mounted to the handle 246. Aluminum oxide can be added to the patch materials to provide for increased survivability in high temperature environments, such as dishwashers.

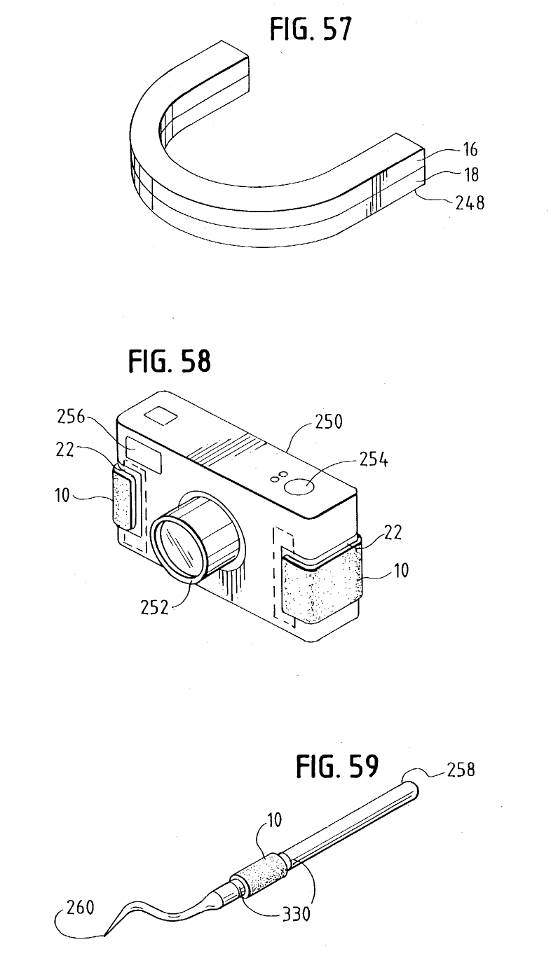

FIG. 57 shows a deformable athletic mouthguard 248. The mouthguard is filled with formable material 20 and has a cross-section similar to that shown in FIG. 3A. The upper membrane 16 and the base 18 are made of flexible silicone material having a thickness sufficient to resist rupturing from dental pressure.

FIG. 58 shows a camera 250 that includes two deformable patches 10. The camera has an optical lens assembly 252 to capture images. An activation button 254 is located on the top of the camera and a flash unit 256 is located adjacent to the lens assembly. The patches 10 can alternatively be configured to have increased width near the lens assembly, so as to provide increased room for the user's fingers. The dotted lines in FIG. 58 represent this optional patch size. It should be appreciated that the patch 10 could be mounted on cameras of any type, including digital and tape video cameras, still cameras and other optical recording devices.

A dental tool 258 incorporating the deformable patch 10 is shown in FIG. 59. The dental tool has a hard pointed end 260 for treating teeth. Aluminum oxide can be added to the patch materials to increase the patch's resistance to high sterilization temperatures. Various shaped deformable patches can be attached to various dental tools, including drills, polishers, x-ray equipment, work station patches and the like.

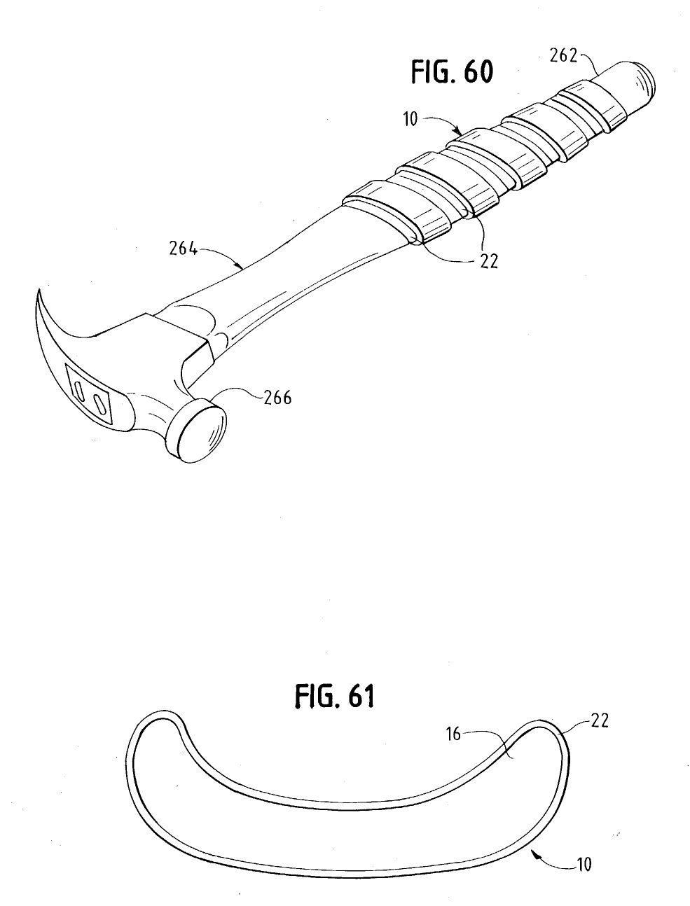

FIG. 60 shows the patch 10 attached to the handle 262 of a hammer 264. In this example, the patch 10 is sized to wrap around the handle of the hammer. The hammer has a metal head 266 configured to drive nails or the like. It should be appreciated that the patch can be configured to attach to any type of hand-held hammer device, such as a sledge hammer, ball-peen hammers, or mallets. The patch can likewise be applied to other tools that have handles.

FIG. 61 shows an embodiment of the patch 10 that has a arc-like, or arcuate, curved shape. Such a curved shape is well suited to receiving the user's fingertips, which tend to make contact with objects not in a straight line, but instead along a curved “footprint.” The components of this patch 10 are the same as those described above and shown in FIG. 2. The patch has an optional edge portion 22 that can be configured as shown in FIG. 3 or 4. Alternatively, the edge portion can be configured as shown in FIG. 3A or 4A. A patch of this shape can be placed on a variety of products having differently shaped surfaces while still maintaining a generally curved area that is sized to accommodate the natural placement of the user's fingertips.

Next, several alternative ways of attaching the patch 10 to the product 12 will be discussed. FIG. 62 shows an embodiment of the patch 10 and product 12 wherein the patch fits within a cavity 268 with an opening 270. The opening of the cavity is defined by overhanging edges 272. Adhesive may be used to hold the patch in the cavity, as may be required by a particular application. In addition, the overhanging edges need not be integral parts of the product 12. Instead the overhanging edges may be separate parts attached to the product 12.

FIG. 63 shows an alternative configuration for the edge portion 22 of the patch 10. In particular, the edge portion may be configured to have a “T” shaped end 274. The “T” shaped end fits in a corresponding “T” shaped channel 276 in the surface of the product 12. Although the T shaped end and channel may adequately fasten the patch to the product, adhesive or mechanical fasteners may also be used.

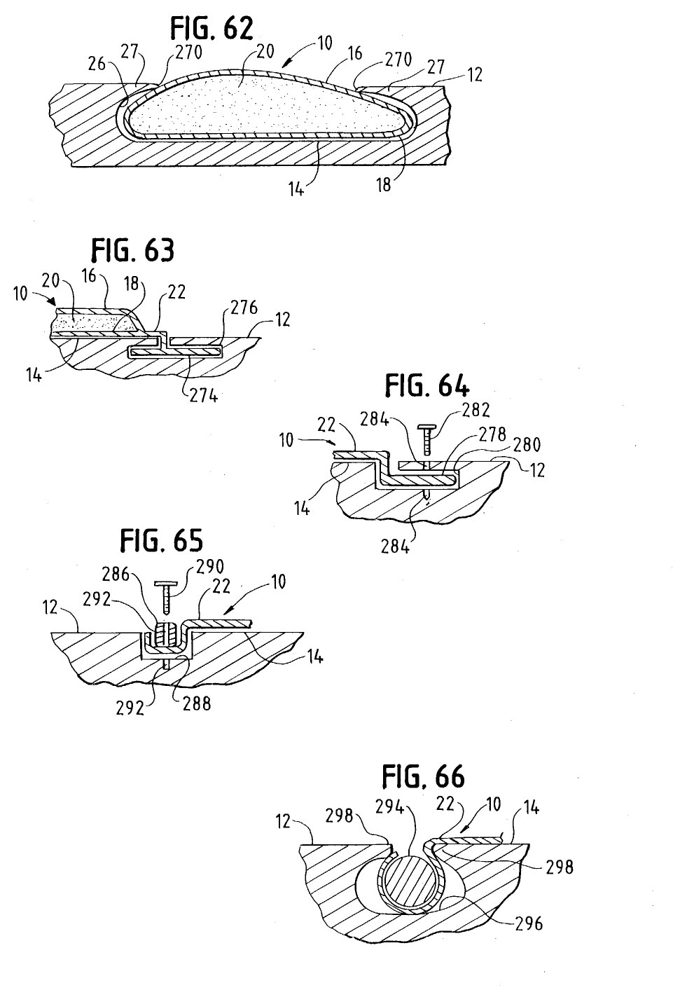

FIG. 64 shows yet another alternative configuration for the edge portion 22 of the patch 10. In particular, the edge portion may be configured to have an “L” shaped end 278 that fits in a corresponding “L” shaped channel 280 in the surface of the product 12. Although the “L” shaped end and channel may adequately fasten the patch to the product, adhesive or mechanical fasteners may also be used, such as screw 282, which fits into hole 284.

FIG. 65 shows yet another alternative method for attaching the edge portion 22 of the patch 10 to the product 12. In particular, the edge portion may be held between a rectangular member 286 and a corresponding channel 288 in the surface of the product 12. Adhesive or mechanical fasteners may also be used to compress the edge portion between the member and the channel, such as screw 290, which fits into hole 292.

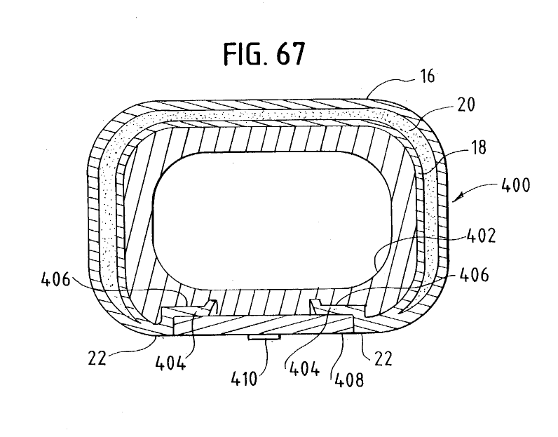

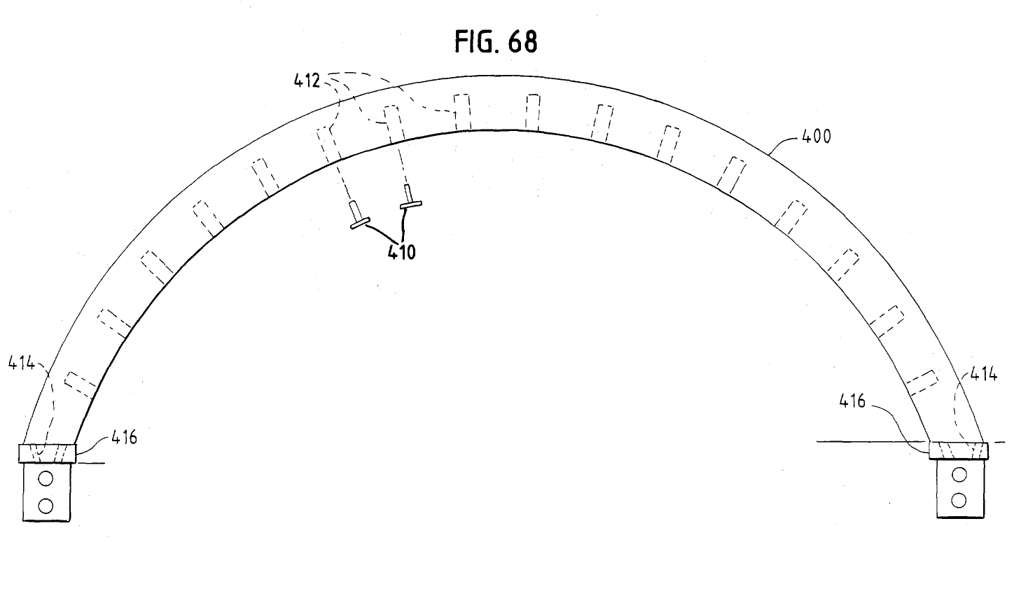

FIG. 66 shows yet another alternative method for attaching the edge portion 22 of the patch 10 to the product 12. In particular, the edge portion may be held between a rod 294 and a corresponding channel 296 in the surface of the product 12. The channel has overhanging edges 298. Adhesive or mechanical fasteners may also be used to compress the edge portion between the member and the channel, but the rod also may be sized to snap between the overhanging edges 298 of the channel 296.

FIGS. 69 and 70 show an alternative steering wheel grip 400 that can be substituted for the steering wheel grip of FIG. 48. In particular, the grip has a flexible upper membrane 16 and a flexible membrane base 18, with the formable material 20 located therebetween. The grip 400 is mounted on the upper portion of the steering wheel 402. Although the steering wheel is shown as hollow in cross section, the grip may be mounted on a solid steering wheel or other steering wheel designs. Each edge portion of the grip has an indented “L” shaped end 404 that conforms to a mating surface 406 on the steering wheel. A mounting strip 408 fastened by screws 410 holds the “L” shaped ends of the side portion against the mating surface 406 of the steering wheel. A series of holes 412 sized to accept the screws is located along the underside of the upper portion of the steering wheel. The holes preferably are spaced about 1 inch apart. The mounting strip can be flexible or rigid. The grip 400 has a two ends 414, each of which is held to the steering wheel by a circular ring 416. The grip 400 can be formed by an extrusion process and the ends 414 of the grip 400 can be formed by bonding the upper membrane to the base so as to enclose the formable material. The ends 414 of the grip look similar to the ends 330 of the sleeve 300 shown in FIG. 5. The thickness of the formable material 20 preferably is 0.1 to 0.150 inch and the thickness of the upper membrane 16 preferably is 0.05 inch. The above described materials may be used for the grip 400.

A tubular patch embodiment 300 is shown in FIGS. 5-9. This sleeve 300 is suitable for attachment to products, such as a pen 302 or a pencil 304 with handles that are cylindrical or that otherwise have a curved or oval cross-section. The sleeve 300 preferably is deformable so that it will closely conform to the fingers of different users. If the sleeve is configured to resume its original shape, the sleeve can be deformed and hold its deformed shape for at least 5 seconds before slowly returning to its original shape. However, depending on the materials used, the sleeve may take much longer to return to its original shape or it may stay in its deformed shape. By conforming to the fingers of each user, the sleeve evenly distributes pressure to the user's fingers, thereby reducing stress and fatigue and increasing the comfort of the user. The sleeve can be permanent or temporary and can be easily removed and replaced in applications where such removal and replacement is advantageous.

As shown in FIGS. 6 and 7A, the deformable sleeve 300 is closed cell having an outer membrane 306 and an inner base 308 that cooperatively encapsulate a formable material 310, like that described above. The base and membrane can be formed of any suitable material, including those described above. As shown in FIGS. 8 and 9, the sleeve can be attached to writing instruments, such as a pen 302 or a pencil 304. The sleeve 300 can be attached to other manual implements that have handles suitable for receiving the tubular-shaped patch 300.

FIGS. 7A and 7B illustrate the assembly of the sleeve 300. The sleeve can be formed by folding a long tubular member 312. The member 312 can be made of molded silicone material and has a larger diameter portion 314 and a smaller diameter portion 316 separated by a transition area 318, as shown in FIG. 7B. In order to form the sleeve 300 of FIG. 7A, the smaller diameter portion 316 is pulled inside the larger diameter portion 314 until the end 320 of the smaller diameter portion is aligned with the end 322 of the larger diameter portion. This can be accomplished by placing the end of a cylindrical tool [not shown] inside the end 320 of the smaller diameter portion 316 and then by moving the larger diameter portion 314 toward the tool and the end of the smaller diameter portion. The tool may be tapered so as to fold the end of the smaller diameter portion radially inwardly, into a position where the end forms a 180° fold and points toward the end of the larger portion. The larger diameter portion is then moved relatively to the smaller portion so the folded end of the smaller portion moves inside the larger portion until the end of the smaller portion is aligned with the end of the larger portion, there by forming one end 324 of the sleeve 300 of FIG. 7A. The other end 326 of the sleeve 300 has a 180° fold 328 and thus does not need any bonding or fastening in order to hold the formable material 310. If the smaller diameter portion 316 is made of rigid material, the larger diameter portion could be folded 180° radially outwardly and pulled over the smaller diameter portion.

When the ends 320 and 322 of the smaller and larger diameter portions 316 and 314 are aligned, the larger diameter portion 314 forms the outer membrane 306 and the smaller diameter portion 316 forms the base 308. The cavity for the formable material 310 is located in the radial space between the base and the outer membrane, which are positioned in a concentric relationship. A small tube [not shown] can be used to inject the formable material 310 between the ends 320 and 322 of the portions and into the cavity. In order to allow air bubbles to escape, the folded end 328 of the sleeve 300 can be placed below the other end 324 of the sleeve. When the formable material 310 has filled the cavity, the tube is removed and the ends of the larger and smaller portion can then be sealed by heat or adhesive, as described above. In addition, before the open end 324 of the sleeve 300 is sealed, a mold may be used to squeeze the outer membrane 306 so as to drive any trapped air out of the sleeve prior to sealing. Alternatively, the sleeve 300 can be formed by placing uncatalyzed material in a press, filling the uncatalyzed material with formable material, and then heating the uncatalyzed material in a heat press to form inner and outer membranes 306 and 308.

The length of the smaller diameter portion 316 can be slightly longer than that of the larger diameter portion 314 so as to create flat edge portions 330 at either end of the sleeve 300. When assembled, the sleeve 300 has a radially inner surface 332 that preferably is cylindrical so as to fit over a product such as a writing instrument body. The sleeve can be held in place by simple friction fit, by adhesives or by mechanical fasteners that hold the flat edge portions 330 at the ends of the sleeve 300. It should be appreciated that, depending on the application, the sleeve may be configured so that the edge portions 330 are minimized or even eliminated. The sleeve need not have such flat edge portions, depending on the requirements of a particular application. Mechanical fasteners may be used to hold the sleeve 300 even if it is configured without flat edge portions 330. The sleeve's edge portions 330 also could be configured as multiple tabs projecting away from each end of the sleeve. The sleeve can be formed by extruding, molding, or other suitable manufacturing processes.

Because the patches identified above can be made with colored materials, the patches can be used to provide an aesthetically pleasing product appearance without much additional increase to the manufacturing cost of the product. In addition, in particular applications such as in the chair of FIG. 25, the patches can provide a comfortable surface for a user to rest his or her arms.

While a particular form of the invention has been illustrated and described, it will be apparent that various modifications can be made without departing from the spirit and scope of the invention. Thus, although the invention has been described in detail with reference only to the preferred embodiments, those having ordinary skill in the art will appreciate that various modifications can be made without departing from the invention. Accordingly, the invention is not intended to be limited, and is defined with reference to the following claims.

1. A deformable sleeve for attachment to a product component, the sleeve comprising:
a first tubular membrane of a flexible material and having a radially outer surface of a predetermined width and a radially inner surface, the radially inner surface defining two openings and a passage of a predetermined size between the openings;
a second tubular membrane of a flexible material and having a width greater than the width of the first membrane, the second membrane located about the first membrane to cooperatively form a cavity between the first and the second membranes; and
a formable material located in the cavity.

2. The deformable sleeve of claim 1, wherein the first and second membranes are bonded together to form the cavity.

3. The deformable sleeve of claim 1, wherein the first and second membranes are formed of one piece of material.

4. The deformable sleeve of claim 3, wherein the piece of material is a flexible tubular member folded on itself from a first position to a second position to define the first and second membranes, the tubular member in the first position defining a first opening, a second opening, and a passageway therebetween.

5. The deformable sleeve of claim 4, wherein the tubular member further defines a first tubular section and a second tubular section when in the first position, wherein the first tubular section extends from the first opening to a predetermined location, and wherein the second tubular section extends from the predetermined location to the second opening.

6. The deformable sleeve of claim 5, wherein the first tubular section has a width greater than the width of the second tubular section.

7. The deformable sleeve of claim 1, wherein the first and second membranes contain aluminum oxide.

8. The deformable sleeve of claim 7, wherein the formable material contains aluminum oxide.

9. The deformable sleeve of claim 1, wherein the formable material contains aluminum oxide.

10. The deformable sleeve of claim 1, wherein the tubular membranes are cylindrical.

11. A deformable sleeve for attachment to a product component, the deformable sleeve comprising:
a first generally tubular and flexible portion having a first end, a second end, a radially outer surface, and a radially inner surface, the radially inner surface defining two openings and a passageway therebetween sized to fit on the product component;
a second generally tubular and flexible portion, the second portion having a first end and a second end, the second end of the second tubular portion located adjacent to the second end of the first tubular portion, the second tubular portion being located about the first portion and the first ends of each portion being located adjacent each other to define a cavity between the first portion and the second portion; and
a formable material located in the cavity.

12. The deformable sleeve of claim 11, wherein the first and second tubular portions are bonded together to form the cavity.

13. The deformable sleeve of claim 11, wherein the first and second tubular portions are formed of one piece of material.

14. The deformable sleeve of claim 13, wherein the piece of material is a flexible tubular member folded on itself from a first position to a second position to define the first and second membranes, the tubular member in the first position defining a first opening, a second opening, and a passageway therebetween.

15. The deformable sleeve of claim 14, wherein the tubular member further defines a first tubular section and a second tubular section when in the first position, wherein the first tubular section extends from the first opening to a predetermined location, and wherein the second tubular section extends from the predetermined location to the second opening.

16. The deformable sleeve of claim 11, wherein the first tubular portion is integrally formed to the second tubular portion.

17. The deformable sleeve of claim 16, wherein the second end of the first tubular portion is integrally joined to the second end of the second tubular portion.

18. The deformable sleeve of claim 11, wherein the first and second membranes contain aluminum oxide.

19. The deformable sleeve of claim 18, wherein the formable material contains aluminum oxide.

20. The deformable sleeve of claim 11, wherein the formable material contains aluminum oxide.

21. The deformable sleeve of claim 11, wherein the tubular membranes are cylindrical.

22. A deformable sleeve for attachment to a product component, the sleeve comprising:
a first generally tubular portion having a first end, a second end, a radially outer surface, and a radially inner surface, the radially inner surface defining a passage sized to fit on the component of the product;
a second generally tubular and flexible portion, the second portion having a first end and a second end, the second end bonded to the second end of the first tubular portion, the second tubular portion being located about the first portion and the first ends of the portions being bonded together to define a cavity between the first portion and the second portion; and
a formable material located in the cavity.

23. The deformable sleeve of claim 22, wherein the first and second tubular portions are formed of one piece of material.

24. The deformable sleeve of claim 23, wherein the piece of material is a flexible tubular member folded on itself from a first position to a second position to define the first and second membranes, the tubular member in the first position defining a first opening, a second opening, and a passageway therebetween.

25. The deformable sleeve of claim 24, wherein the tubular member further defines a first tubular section and a second tubular section when in the first position, wherein the first tubular section extends from the first opening to a predetermined location, and wherein the second tubular section extends from the predetermined location to the second opening.

26. The deformable sleeve of claim 22, wherein the first tubular portion is integrally formed to the second tubular portion.

27. The deformable sleeve of claim 26, wherein the second end of the first tubular portion is integrally joined to the second end of the second tubular portion.

28. The deformable sleeve of claim 22, wherein the first and second membranes contain aluminum oxide.

29. The deformable sleeve of claim 28, wherein the formable material contains aluminum oxide.

30. The deformable sleeve of claim 22, wherein the formable material contains aluminum oxide.

31. The deformable sleeve of claim 22, wherein the tubular membranes are cylindrical.

32. A product comprising:
a body having a portion with a predetermined thickness;
a first generally tubular and flexible membrane having a radially outer surface and a radially inner surface defining a passageway, the radially inner surface being located about the portion of the product;
a second generally tubular and flexible membrane, the second membrane being located about the first membrane, thereby defining a cavity between the first membrane and the second membrane; and
a formable material located in the cavity.

33. The product of claim 32, wherein the first and second membranes are formed of one piece of material.

34. The product of claim 33, wherein the piece of material is a flexible tubular member folded on itself from a first position to a second position to define the first and second membranes, the tubular member in the first position defining a first opening, a second opening, and a passageway therebetween.

35. The product of claim 34, wherein the tubular member in the first position further defines a first tubular section and a second tubular section, wherein the first tubular section extends from the first opening toward the second opening, terminating at a predetermined location therebetween, and wherein the second tubular section extends from the predetermined location to the second opening.

36. The product of claim 35, wherein the first tubular section has a maximum width larger than the width of the second tubular section.

37. The product of claim 32, wherein the body has a first end, a second end, and a long and narrow shape, the body further containing a writing mechanism projecting from the first end of the body, and wherein the deformable sleeve is mounted on the body adjacent to the writing mechanism.

38. The product of claim 32, wherein the body portion is a handle.

39. The product of claim 32, wherein the first and second membranes contain aluminum oxide.

40. The product of claim 39, wherein the formable material contains aluminum oxide.

41. The product of claim 32, wherein the formable material contains aluminum oxide.

42. The product of claim 32, wherein the tubular membranes are cylindrical.

43. A product comprising:
a body having a portion with a predetermined thickness;
a first generally tubular and flexible membrane having a radially outer surface and a radially inner surface defining a passageway, the radially inner surface being located about the portion of the product,
a second generally tubular and flexible portion, the second portion having a first end and a second end, the second end bonded to the second end of the first tubular portion, the second tubular portion being located about the first portion and the first ends of the portions being fastened together to define a cavity between the first portion and the second portion; and
a formable material located in the cavity.

44. The product of claim 43, wherein the first and second membranes are formed of one piece of material.

45. The product of claim 44, wherein the piece of material is a flexible tubular member folded on itself from a first position to a second position to define the first and second membranes, the tubular member in the first position defining a first opening, a second opening, and a passageway therebetween.

46. The product of claim 45, wherein the tubular member in the first position further defines a first tubular section and a second tubular section, wherein the first tubular section extends from the first opening toward the second opening, terminating at a predetermined location therebetween, and wherein the second tubular section extends from the predetermined location to the second opening.

47. The product of claim 46, wherein the first tubular section has a maximum width larger than the width of the second tubular section.

48. The product of claim 43, wherein the body has a first end, a second end, and a long and narrow shape, the body further containing a writing mechanism projecting from the first end of the body, and wherein the deformable sleeve is mounted on the body adjacent to the writing mechanism.

49. The product of claim 43, wherein the body portion is a handle.

50. The product of claim 43, wherein the first and second membranes contain aluminum oxide.

51. The product of claim 50, wherein the formable material contains aluminum oxide.

52. The product of claim 43, wherein the formable material contains aluminum oxide.

53. The product of claim 43, wherein the tubular membranes are cylindrical.
